(19) United States
(12) Patent Application Publication
(10) Pub. No.: US 2023/0158611 A1
(43) Pub. Date: May 25, 2023

(54) TANK AND MANUFACTURING METHOD THEREOF

(71) Applicant: NORITZ CORPORATION, HYOGO (JP)

(72) Inventors: Naoki SE, Hyogo (JP); Nobuhiro FUKUI, Hyogo (JP); Hideyuki FUJISAWA, Hyogo (JP)

(73) Assignee: NORITZ CORPORATION, HYOGO (JP)

(21) Appl. No.: 17/984,224

(22) Filed: Nov. 9, 2022

(30) Foreign Application Priority Data
Nov. 19, 2021 (JP) 2021-188672

(51) Int. Cl. B23K 33/00; B23K 9/032; B23K 37/053

(52) U.S. Cl. CPC B23K 33/006; B23K 9/032; B23K 37/053; B23K 2101/12

(57) ABSTRACT

A tank includes: a bowl-shaped head having a peripheral wall whose base end side is open; and a tubular body member having an end in an axial length direction joined to the head. The peripheral wall of a region of the head close to a base end is an inclined peripheral wall whose inner diameter increases toward the base end. The end of the body member is inserted inside the inclined peripheral wall of the head and is joined to an inner peripheral surface of the inclined peripheral wall via a weld. A mark available for use in determining a position of the end of the body member is provided in a position on an outer peripheral surface of the body member on a central part side of the body member in the axial length direction with respect to the head and away from the end by a predetermined dimension.

### CROSS-REFERENCE TO RELATED APPLICATIONS

This application claims the priority benefit of Japan Application No. 2021-188672, filed on Nov. 19, 2021. The entirety of the above-mentioned patent application is hereby incorporated by reference herein and made a part of this specification.

### BACKGROUND

### Technical Field

The disclosure relates to a tank such as a hot water storage tank used in, for example, a heat pump water heater, and to a manufacturing method for manufacturing such a tank.

### Related Art

A specific example of a conventional tank is shown in FIG. 7.

A tank Te shown in FIG. 7 has a configuration in which a bowl-shaped head 2e is fitted to an end of a tubular body member 1e, and a weld 99 is provided therebetween. An opening peripheral edge of the head 2e is formed as an inclined peripheral wall 29 whose outer diameter decreases toward a base end side, and the inclined peripheral wall 29 is inserted into the body member 1e. According to such a configuration, it is possible to simplify an overall assembly structure of the tank Te and reduce the manufacturing cost thereof.

In the tank Te, a crevice C is formed between the inclined peripheral wall 29 of the head 2e and the end of the body member 1e. The crevice C is located inside the tank Te, and a liquid stored in the tank Te flows into the crevice C. Hence, there is concern that corrosion (crevice corrosion) is likely to occur in a place where the crevice C is formed. As a result, a material excellent in corrosion resistance and high in price is required for the tank Te.

Specific examples of the related art include, in addition to the one shown in FIG. 7, a tank described in Patent Document 1. In this tank, after an end of a tubular body member is fitted onto an opening peripheral edge of a head, welding is performed that melts the entire end of the body member located outside the head. According to such a configuration, a crevice regarded as a main cause of crevice corrosion can be prevented from occurring inside the tank. However, according to such a configuration, since welding is required that melts a quite wide region of the end of the body member without excess or shortage, the welding is not easy, and the possibility of causing welding defects increases. The amount of energy consumed by welding may also increase.
[Patent Document 1] Japanese Patent Laid-open No. 2009-183963
[Patent Document 2] Japanese Patent No. 2593233
[Patent Document 3] Japanese Patent No. 6048659

### SUMMARY

A tank according to one aspect of the disclosure includes: a head, having a bowl shape and having a peripheral wall whose base end side is open; and a body member, having a tubular shape and having an end in an axial length direction joined to the head. The peripheral wall of a region of the head close to a base end is an inclined peripheral wall whose inner diameter increases toward the base end side. The end of the body member is inserted inside the inclined peripheral wall of the head and is joined to an inner peripheral surface of the inclined peripheral wall via a weld. A mark for end position determination available for use in determining a position of the end of the body member is provided in a position on an outer peripheral surface of the body member that is on a central part side of the body member in the axial length direction with respect to the head and is away from the end by a predetermined dimension.

A manufacturing method of a tank according to another aspect of the disclosure includes a welding process for welding an end of a body member in an axial length direction to a head having a bowl shape and having a peripheral wall whose base end side is open. As the head, one is used in which a peripheral wall of a region close to a base end is an inclined peripheral wall whose inner diameter increases toward the base end side. As the body member, one is used in which a mark for end position determination is provided in a position on an outer peripheral surface of the body member that is in a region on a central part side of the body member in the axial length direction with respect to the head during execution of the welding process and is away from the end of the body member by a predetermined dimension. In the welding process, the end of the body member is welded to an inner peripheral surface of the inclined peripheral wall with the end inserted inside the head, and a position of the welding is determined based on the mark.

### BRIEF DESCRIPTION OF THE DRAWINGS

FIG. 1 is a sectional view showing an example of a tank according to the disclosure.

FIG. 2 is an exploded sectional view of the tank shown in FIG. 1

FIG. 3 is a sectional view showing a welding process in a manufacturing method of the tank shown in FIG. 1.

(a) and (b) of FIG. 4 are perspective views showing a manufacturing process of a body member of the tank shown in FIG. 1.

(a) of FIG. 5 is an explanatory front view showing an example of a state in which a workpiece shown in FIG. 4 is subjected to roll forming, and (b) of FIG. 5 is a right side view of (a) of FIG. 5.

(a) and (b) of FIG. 6 are schematic perspective views showing another example of the disclosure.

FIG. 7 is a sectional view showing an example of the related art.

### DESCRIPTION OF THE EMBODIMENTS

The disclosure provides a tank in which welding between a body member and a head can be easily and accurately performed and crevice corrosion or the like can be made less likely to occur, and a tank manufacturing method in which a tank as described above can be appropriately manufactured.

The disclosure employs the following technical means.

A tank provided according to a first aspect of the disclosure includes: a head, having a bowl shape and having a peripheral wall whose base end side is open; and a body member, having a tubular shape and having an end in an axial length direction joined to the head. The peripheral wall of a region of the head close to a base end is an inclined peripheral wall whose inner diameter increases toward the base end side. The end of the body member is inserted inside the inclined peripheral wall of the head and is joined to an inner peripheral surface of the inclined peripheral wall via a weld. A mark for end position determination available for use in determining a position of the end of the body member is provided in a position on an outer peripheral surface of the body member that is on a central part side of the body member in the axial length direction with respect to the head and is away from the end by a predetermined dimension.

According to such a configuration, the following may be achieved.

Firstly, even if a crevice is formed between the inclined peripheral wall of the head and the outer peripheral surface of the body member, this crevice is not substantially located inside the tank and is located outside (outer side portion of) the tank. Hence, a problem that crevice corrosion is likely to occur due to the crevice formed between the head and the body member can be appropriately solved. The necessity of using a material excellent in corrosion resistance and high in price for the tank can be eliminated or reduced, and the tank can be reduced in cost.

Secondly, since the end of the body member is located inside the inclined peripheral wall of the head, this portion cannot be visually observed from the outside. For this reason, it would originally be difficult to accurately perform welding on the end of the body member. However, according to the disclosure, based on the mark for end position determination that is provided on the outer peripheral surface of the body member and can be visually observed, it is possible to accurately determine the position of the end of the body member and appropriately perform welding such as laser welding on this portion. It suffices if the weld in the disclosure joins the inclined peripheral wall of the head and the end of the body member to each other. Unlike Patent Document 1, a weld that melts an entire predetermined region of the head without excess or shortage is not necessary. Thus, it is possible to easily and appropriately perform welding work, and productivity of the tank can be improved.

As a method for determining the position of the end of the body member, it is conceivable to use a base end of the head as a reference. However, since the head and the body member are separately provided, according to such a method, error may increase and accuracy in determining the position of the end of the body member may deteriorate. According to the disclosure, there is no such defect.

In the disclosure, preferably, the weld is provided so as to bury a corner formed between a tip surface of the end of the body member and the inner peripheral surface of the inclined peripheral wall of the head with a weld bead.

According to such a configuration, since the corner formed between the tip surface of the end of the body member and the inner peripheral surface of the inclined peripheral wall of the head is substantially absent, corrosion arising from the corner can be made less likely to occur. That is, if the corner has, for example, a deep and narrow shape, even if there is concern that corrosion (crevice corrosion) is likely to occur in this portion, according to the aforesaid configuration, it is possible to eliminate such concern and improve corrosion resistance of the tank.

In the disclosure, preferably, the mark is provided as a continuous or intermittent mark line extending in a circumferential direction of the outer peripheral surface of the body member, or a plurality of the marks are provided at intervals in the circumferential direction.

According to such a configuration, it is possible to easily and accurately recognize the mark, and an operation or processing for determining a position of the end of the body member based on the mark can be facilitated and accelerated.

A manufacturing method of a tank provided according to a second aspect of the disclosure includes a welding process for welding an end of a body member in an axial length direction to a head having a bowl shape and having a peripheral wall whose base end side is open. As the head, one is used in which a peripheral wall of a region close to a base end is an inclined peripheral wall whose inner diameter increases toward the base end side. As the body member, one is used in which a mark for end position determination is provided in a position on an outer peripheral surface of the body member that is in a region on a central part side of the body member in the axial length direction with respect to the head during execution of the welding process and is away from the end of the body member by a predetermined dimension. In the welding process, the end of the body member is welded to an inner peripheral surface of the inclined peripheral wall with the end inserted inside the head, and a position of the welding is determined based on the mark.

According to such a configuration, it is possible to appropriately manufacture the tank provided according to the first aspect of the disclosure, and similar effects to those described of the aforesaid tank can be achieved. That is, according to the aforesaid configuration, it is possible to appropriately manufacture a tank in which welding between a body member and a head can be easily and accurately performed and crevice corrosion or the like is less likely to occur.

In the disclosure, preferably, the mark is arranged away from a tip surface of the end of the body member by a predetermined first dimension. In the welding process, a position away from the mark toward the end side of the body member by a predetermined second dimension shorter than the first dimension is a welding target position.

According to such a configuration, it is possible to set a position on the central part side of the body member by a predetermined dimension (difference between the first dimension and the second dimension) from the tip surface of the end of the body member as the welding target position, and appropriately perform welding on the end of the body member.

In the disclosure, preferably, as a manufacturing process of the body member, a roll forming process is provided in which a workpiece having a flat plate shape as a raw material of the body member is subjected to roll forming while being conveyed on a predetermined conveyance path. In the roll forming process, the mark is provided on the workpiece by using a marking device installed in advance in a place corresponding to the conveyance path.

According to such a configuration, the mark can be provided when the roll forming process for manufacturing the body member is executed, which is therefore rational. Compared with a case where a dedicated process for providing the mark on the body member is executed separately from the roll forming process, it is possible to increase productivity of the tank and reduce the manufacturing cost.

The disclosure will be clearer from the following description of embodiments of the disclosure with reference to the accompanying drawings.

Hereinafter, an embodiment of the disclosure will be specifically described with reference to the drawings.

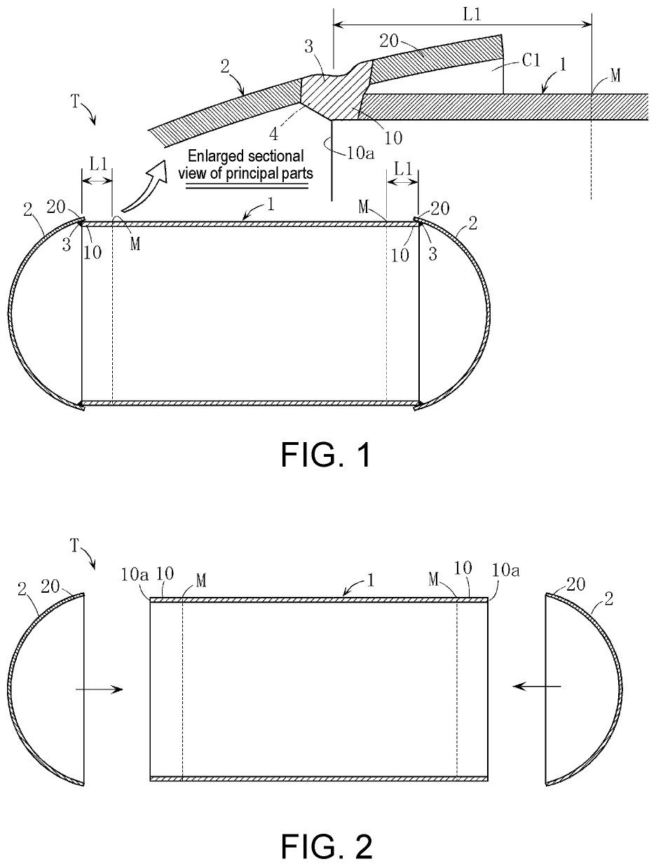

A tank T of the present embodiment shown in FIG. 1 is used as, for example, a hot water storage tank for a water heater of a heat pump type or a cogeneration system type. The tank T includes a body member 1 having a cylindrical shape, a pair of heads 2 having a bowl shape, a weld 3 joining the body member 1 and the heads 2 to each other, and two mark lines M for determining a position of an end 10 of the body member 1.

The body member 1 and the pair of heads 2 are made of, for example, stainless steel. In the present embodiment, the pair of heads 2 have the same shape and size. However, the pairs may have different shapes and sizes.

Each head 2 is formed by subjecting a stainless steel plate as a raw material to deep drawing or spinning, and has a bowl shape whose base end side is open. A peripheral wall of a region of the head close to a base end 2 is an inclined peripheral wall 20 whose inner diameter increases toward the base end side of the head 2.

The body member 1 has a cylindrical shape. The end 10 (each of both left and right ends 10) of the body member 1 in an axial length direction is inserted inside the inclined peripheral wall 20 of the head 2, and is joined to an inner peripheral surface of the inclined peripheral wall 20 via the weld 3.

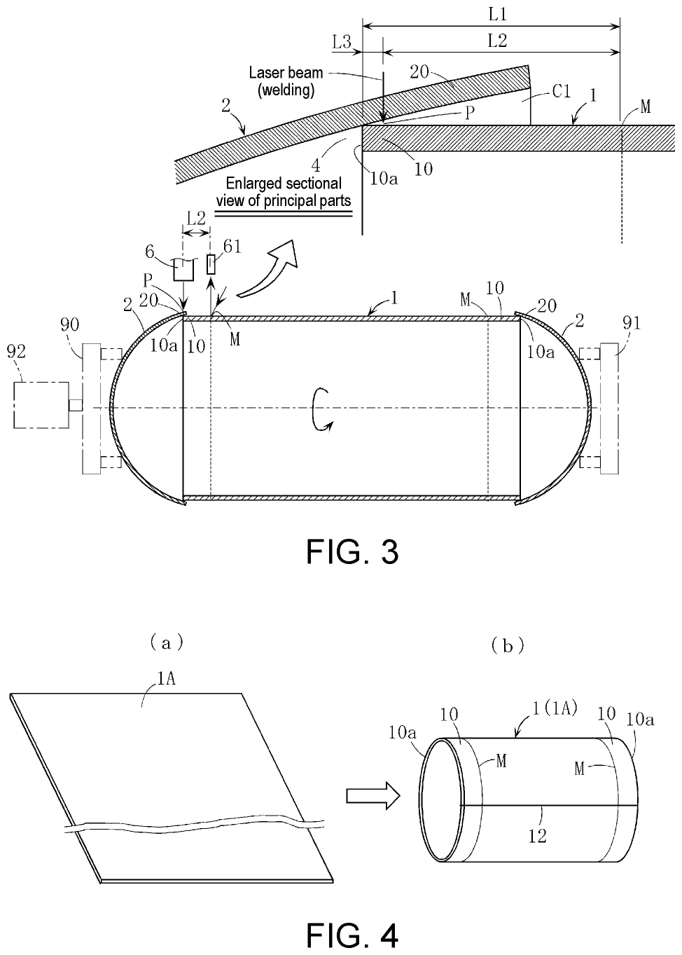

As will be described later, the weld 3 is, for example, a laser welded portion. In an enlarged sectional view of principal parts of FIG. 3 in which the weld 3 is not provided, a corner 4 is formed between a tip surface 10a of the end 10 of the body member 1 and the inner peripheral surface of the inclined peripheral wall 20 of the head 2. The weld 3 is provided so as to bury the corner 4 with a weld bead (part of the weld 3) and cause the corner 4 to disappear.

The mark line M corresponds to a specific example of a “mark for end position determination” mentioned in the disclosure. The mark line M has, for example, an annular shape continuously extending in a circumferential direction of an outer peripheral surface of the body member 1 and provided over substantially the entire circumference of the outer peripheral surface (see also FIG. 4).

The mark line M is provided in a position on the outer peripheral surface of the body member 1 that is on a central part side of the body member 1 in the axial length direction with respect to each head 2 and is away from the end 10 (strictly the tip surface 10a) of the body member 1 by a predetermined first dimension L1. The mark line M is, for example, a marking-off line provided by bringing a scriber or a similar tool into contact with a surface on the outer peripheral surface of the body member 1, a concave groove-like line formed by laser irradiation, or a line displayed using ink paint.

Next, an example of a manufacturing method of the tank T will be described.

First, as shown in FIG. 2, after the body member 1 and the pair of heads 2 are prepared, a welding process shown in FIG. 3 is performed. However, the configurations of the body member 1 and the head 2 are as described above, and details of the welding process shown in FIG. 3 will be described later.

(b) of FIG. 4 is a perspective view of the body member 1. As shown in (a) of FIG. 4, a stainless steel plate 1A (workpiece 1A) having a flat plate shape is used as a raw material of the body member 1. By subjecting the workpiece 1A to roll forming into a cylindrical shape and welding a seam portion 12 between a starting end and a terminal end of roll forming, the body member 1 is manufactured. As described below, the mark line M is provided during roll forming of the workpiece 1A.

FIG. 5 shows an example of a roll forming process using a roll forming apparatus 8. In the roll forming process, the workpiece 1A having a flat plate shape is sent to a roll forming part 81 by using a constant conveyance path 80 equipped with a feed roller 80a or the like, and is rolled into a cylindrical shape. The roll forming part 81 is a portion in which the workpiece 1A can be bent, for example, by passing the workpiece 1A between a plurality of bending rollers (not shown), and is conventionally known.

On the other hand, in a place corresponding to the conveyance path 80, a marking device 7 is provided so as to be able to provide the mark line M on the workpiece 1A by facing or contacting a desired place on the workpiece 1A during conveyance of the workpiece 1A. The marking device 7 is, for example, a marking-off device able to bring a scriber or a similar tool into contact with a surface of the workpiece 1A and provide the mark line M as a marking-off line, a laser irradiation device (laser welding device) able to irradiate the surface of the workpiece 1A with a laser beam and provide the mark line M having a concave groove shape, or a printer able to apply ink paint to the surface of the workpiece 1A and print and display the mark line M.

During execution of the roll forming process of the workpiece 1A having a flat plate shape, the mark line M of the body member 1 is provided on the workpiece 1A by using the marking device 7. In this way, manufacturing work of the tank T can be rationalized.

The marking device 7 is positionally adjustable in a width direction (direction of arrow Na in (b) of FIG. 5) of the workpiece 1A, and the dimension L1 (first dimension) from both end faces (corresponding to both tip surfaces 10a) of the workpiece 1A to the mark line M can be arbitrarily set. Reference numeral 85 in (b) of FIG. 5 denotes a guide roller that rotates in contact with both end faces of the workpiece 1A when the workpiece 1A is conveyed. A dimension L1 from an outer peripheral surface of the guide roller 85 to the marking device 7 corresponds to the dimension L1 from the tip surface 10a of the body member 1 to the mark line M.

FIG. 3 shows a welding process of the body member 1 and the head 2.

In this welding process, the end 10 of the body member 1 is assembled while having been inserted inside the inclined peripheral wall 20 of the head 2 in advance. The welding is, for example, laser welding, in which a laser beam is irradiated from a laser welding head 6 of a laser welding device (whose entire configuration is omitted from illustration) to the inclined peripheral wall 20 of the head 2 with the end 10 of the body member 1 as a target. Strictly, an irradiation position P of the laser beam is, for example, a position on the central part side of the body member 1 from the tip surface 10a of the end 10 by a predetermined dimension L3. Hence, the irradiation position P of the laser beam is a position horizontally away from the mark line M toward the end 10 side of the body member 1 by a dimension L2 (L2=L1-L3, second dimension).

The mark line M is located on the central part side of the body member 1 in the axial length direction with respect to the head 2 and can be visually observed. The mark line M can be recognized by causing a read head 61 of a mark reading device (whose entire configuration is omitted from illustration) equipped with an image sensor or the like to face the mark line M. By controlling the arrangement of the laser welding head 6 based on a reading position of the mark line M by the read head 61, it is possible to accurately irradiate the irradiation position P with a laser beam.

The body member 1 and the head 2 are rotated about their central axes by using a motor 92 while held by suitable clamping members 90 and 91. Accordingly, laser welding is performed over the entire circumference of a predetermined place in the body member 1 and the head 2. By performing this laser welding, it is possible to provide the weld 3 (weld bead) shown in FIG. 1 and appropriately manufacture the tank T.

Next, functions of the tank T will be described.

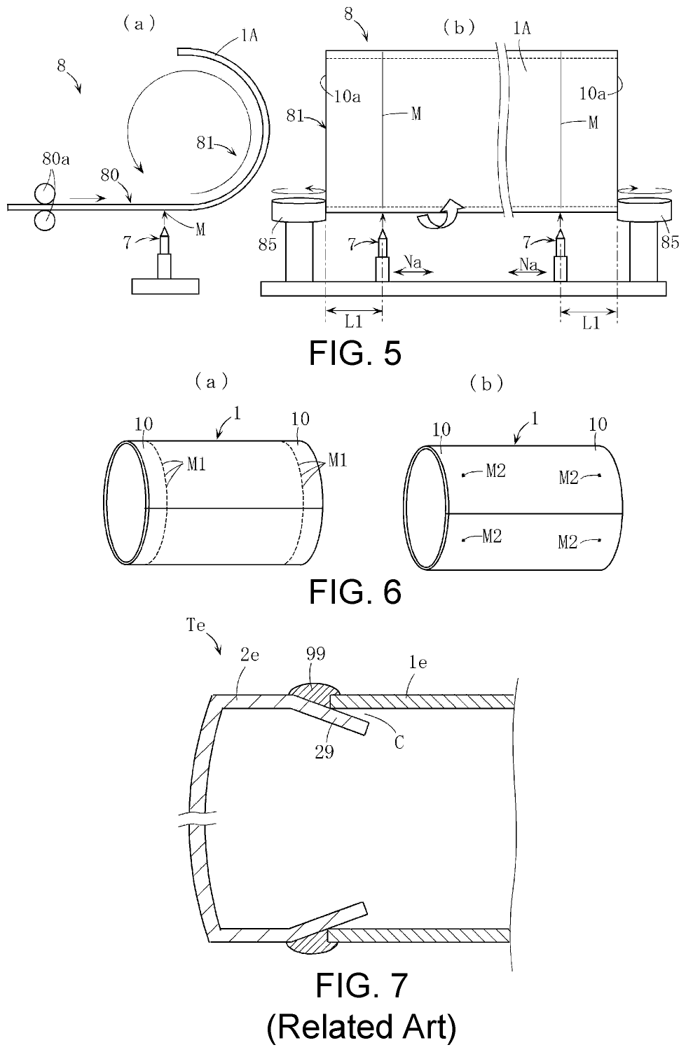

First, in the tank T, a crevice like the crevice C shown in FIG. 7 is not formed inside the tank T. A crevice C1 is formed between the body member 1 and the inclined peripheral wall 20 of the head 2, and the crevice C1 is located on an outer side of the tank T. Accordingly, it is possible to suppress crevice corrosion within the tank T. Since the corner 4 shown in the enlarged sectional view of principal parts of FIG. 3 is buried by the weld bead of the weld 3, crevice corrosion arising from the corner 4 does not occur. Thus, it is possible to make the tank T of the present embodiment excellent in corrosion resistance. As a result, the necessity of using stainless steel that is excellent in corrosion resistance and high in price as a material of each part of the tank T can be eliminated or reduced, and the manufacturing cost of the tank T can be reduced.

The end 10 of the body member 1 to which the weld 3 is to be provided is located inside the head 2 and is difficult to visually observe. However, as shown in FIG. 3, it is possible to identify the position of the end 10 based on the mark line M and perform welding in an originally proper position. Since the mark line M is an annular line provided over the entire circumference of the outer peripheral surface of the body member 1, the mark line M can be easily and accurately recognized by an operator or the aforesaid mark reading device. Since alignment of the laser welding head 6 of the laser welding device (alignment of the irradiation position P of the laser beam) may be performed if the position of the laser welding head 6 is arranged horizontally away from the mark line M by the predetermined dimension L3, the alignment work is also easy. Thus, welding work can be easily and appropriately performed, and productivity of the tank T can be improved.

FIG. 6 shows another embodiment of the disclosure. In FIG. 6, elements identical or similar to those of the above embodiment are denoted by the same reference numerals as in the above embodiment, and repeated descriptions are omitted.

In (a) of FIG. 6, a mark M1 is a mark line having a linear (dotted line) shape intermittently extending in the circumferential direction of the outer peripheral surface of the body member 1. In (b) of FIG. 6, a mark M2 is regarded to have a non-linear shape (such as a dot shape) instead of a linear shape and is provided in a plurality of places on the outer peripheral surface of the body member 1 at appropriate intervals in the circumferential direction.

As described above, if a mark is provided as a mark line extending in the circumferential direction of the outer peripheral surface of the body member, or if a plurality of marks, while not provided as mark lines, are provided at intervals in the circumferential direction, the mark becomes easy to recognize, which is favorable.

Nevertheless, the type (linear or non-linear) or number of the mark does not matter, and there may be a configuration provided with only one mark. A character, a figure, a symbol, or the like may be used as the mark. As already mentioned, the mark can be provided by, for example, ink paint application, scribing, or laser irradiation. However, the mark may be provided by means other than those mentioned above. The mark may be a three-dimensional mark such as a concave mark or a convex mark.

The disclosure is not limited to the content of the above embodiments. The specific configuration of each part of the tank according to the disclosure may be modified in various ways within the intended scope of the disclosure. Similarly, the specific configuration of each step of the tank manufacturing method according to the disclosure can be modified in various ways.

The specific shape, size, and material of the body member or the head are not limited to the content of the above embodiments. As mentioned, the specific configuration of the mark for end position determination is not limited. However, an operation for providing the mark can be performed separately from the roll forming process of the workpiece as shown in FIG. 5.

The welding is suitably laser welding, and other types of welding are also possible. Although there is no need to use a filler material in laser welding, a filler material may be used.

The tank according to the disclosure is not limited to a hot water storage tank for a water heater, and can be configured as a tank of other type. Accordingly, the material of the tank is not limited to stainless steel, and may be changed according to the type of fluid to be stored in the tank.

What is claimed is:

1. A tank, comprising:
a head, having a bowl shape and having a peripheral wall whose base end side is open; and
a body member, having a tubular shape and having an end in an axial length direction joined to the head, wherein
the peripheral wall of a region of the head close to a base end is an inclined peripheral wall whose inner diameter increases toward the base end side;
the end of the body member is inserted inside the inclined peripheral wall of the head and is joined to an inner peripheral surface of the inclined peripheral wall via a weld;
a mark for end position determination available for use in determining a position of the end of the body member is provided in a position on an outer peripheral surface of the body member that is on a central part side of the body member in the axial length direction with respect to the head and is away from the end by a predetermined dimension.

2. The tank according to claim 1, wherein
the weld is provided so as to bury a corner formed between a tip surface of the end of the body member and the inner peripheral surface of the inclined peripheral wall of the head with a weld bead.

3. The tank according to claim 1, wherein
the mark is provided as a continuous or intermittent mark line extending in a circumferential direction of the outer peripheral surface of the body member, or a plurality of the marks are provided at intervals in the circumferential direction.

4. The tank according to claim 2, wherein
the mark is provided as a continuous or intermittent mark line extending in a circumferential direction of the outer peripheral surface of the body member, or a plurality of the marks are provided at intervals in the circumferential direction.

5. A manufacturing method of a tank, comprising:
a welding process for welding an end of a body member in an axial length direction to a head having a bowl shape and having a peripheral wall whose base end side is open;
using, as the head, one in which the peripheral wall of a region close to a base end is an inclined peripheral wall whose inner diameter increases toward the base end side; and
using, as the body member, one in which a mark for end position determination is provided in a position on an outer peripheral surface of the body member that is in a region on a central part side of the body member in the axial length direction with respect to the head during execution of the welding process and is away from the end of the body member by a predetermined dimension, wherein
the welding process comprises welding the end of the body member to an inner peripheral surface of the inclined peripheral wall with the end inserted inside the head, and determining a position of the welding based on the mark.

6. The manufacturing method of a tank according to claim 5, wherein
the mark is arranged away from a tip surface of the end of the body member by a predetermined first dimension; and
the welding process comprises setting a position away from the mark toward the end side of the body member by a predetermined second dimension shorter than the first dimension as a welding target position.

7. The manufacturing method of a tank according to claim 5, comprising:
as a manufacturing process of the body member, a roll forming process for subjecting a workpiece having a flat plate shape as a raw material of the body member to roll forming while conveying the workpiece on a predetermined conveyance path, wherein
the roll forming process comprises providing the mark on the workpiece by using a marking device installed in advance in a place corresponding to the conveyance path.

8. The manufacturing method of a tank according to claim 6, comprising:
as a manufacturing process of the body member, a roll forming process for subjecting a workpiece having a flat plate shape as a raw material of the body member to roll forming while conveying the workpiece on a predetermined conveyance path, wherein
the roll forming process comprises providing the mark on the workpiece by using a marking device installed in advance in a place corresponding to the conveyance path.
